(19) United States
(12) Patent Application Publication
(10) Pub. No.: US 2020/0094565 A1
(43) Pub. Date: Mar. 26, 2020

(54) INK JET PRINTER

(71) Applicant: Roland DG Corporation, Hamamatsu-shi (JP)

(72) Inventor: Bunji SHINOMIYA, Hamamatsu-shi (JP)

(21) Appl. No.: 16/563,979

(22) Filed: Sep. 9, 2019

(30) Foreign Application Priority Data
Sep. 21, 2018 (JP) 2018-177129

(51) Int. Cl. B41J 2/175

(52) U.S. Cl. CPC B41J 2/17503

(57) ABSTRACT

An ink jet printer includes a printer body and a carriage. The ink jet printer further includes a main ink container and a first attachment that are mounted on the printer body and a sub-ink container and a second attachment that are mounted on the carriage. The first attachment is connected to the main ink container. The second attachment is connected to the sub-ink container. The first attachment and the second attachment are connected to each other when the carriage is set in a first position. The main ink container and the sub-ink container communicate with each other when the first attachment and the second attachment are connected to each other.

### CROSS REFERENCE TO RELATED APPLICATIONS

This application claims the benefit of priority to Japanese Patent Application No. 2018-177129 filed on Sep. 21, 2018. The entire contents of this application are hereby incorporated herein by reference.

### BACKGROUND OF THE INVENTION

### 1. Field of the Invention

The present invention relates to an ink jet printer.

### 2. Description of the Related Art

Conventionally, ink jet printers in which an ink head is mounted on a carriage configured to move have been known. For example, a printing device including a carriage configured to move in a main scanning direction, an ink container mounted on a main body, an ink jet head mounted on the carriage, and an ink flow path connecting the ink container and the ink jet head is described in Japanese Laid-open Patent Publication No. 2017-24217.

For example, in an ink jet printer including a carriage configured to move as in Japanese Laid-open Patent Publication No. 2017-24217, an ink is supplied to an ink jet head mounted on the carriage from an ink container mounted on a main body. This supply is performed via an ink flow path, such as a tube or the like. The carriage moves during a printing time, and accordingly, the ink flow path has to have a length that is sufficient for movement of the carriage. Therefore, a large space is needed for arranging the ink flow path.

### SUMMARY OF THE INVENTION

Preferred embodiments of the present invention provide ink jet printers in each of which a large space used to arrange an ink flow path is not needed.

An ink jet printer disclosed herein includes a printer body, a carriage, a carriage mover, a main ink container, a first attachment, a sub-ink container, an ink head, and a second attachment. The carriage movably engages with the printer body. The carriage mover moves the carriage. The main ink container is provided in the printer body and the ink is stored in the main ink container. The first attachment is provided in the printer body and is connected to the main ink container. The sub-ink container is mounted on the carriage. The ink head is mounted on the carriage and is connected to the sub-ink container. The second attachment is mounted on the carriage and is connected to the sub-ink container. The carriage mover is configured to set the carriage in a first position. The first attachment and the second attachment are configured to be connected to each other when the carriage is set in the first position. The main ink container and the sub-ink container communicate with each other when the first attachment and the second attachment are connected to each other.

According to the above described ink jet printer, an ink flow path extending between the printer body and the carriage is not needed, and therefore, a large space used to arrange the ink flow path is not needed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a front view of a printer according to a preferred embodiment of the present invention.

FIG. 2 is a schematic view illustrating a configuration of an ink system.

FIG. 3 is a cross-sectional view schematically illustrating a sub-ink container.

FIG. 4 is a block diagram of a printer.

FIG. 5 is a schematic view illustrating an example of a configuration of a known ink system.

### DETAILED DESCRIPTION OF THE PREFERRED EMBODIMENTS

With reference to the attached drawings, ink jet printers according to preferred embodiments will be described below. Note that, as a matter of course, preferred embodiments described herein are not intended to be particularly limiting of the present invention. Also, elements and portions that have the same function are denoted by the same reference character and redundant description will be omitted or simplified, as appropriate. In the following description, when an ink jet printer is viewed from front, a direction away from the ink jet printer is a forward direction and a direction approaching the ink jet printer is a rear direction. Also, reference symbols F, Rr, L, R, U, and D indicate front, rear, left, right, up, and down, respectively. These directions are used herein merely for convenience of description and do not limit setting modes or the like of the ink jet printer.

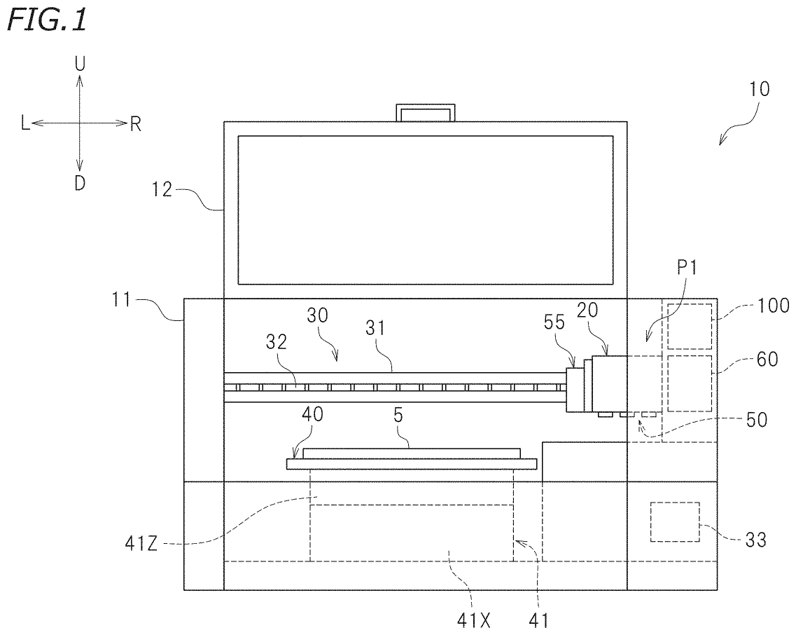

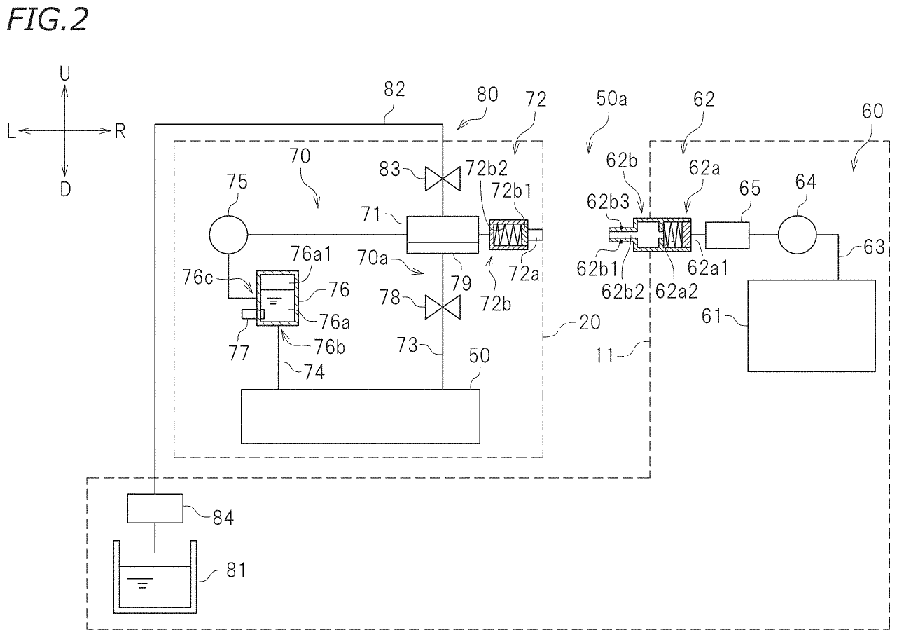

As illustrated in FIG. 1, a printer 10 includes a printer main body 11, a carriage 20, and a carriage mover 30. The printer main body 11 includes a flat bed 40, a portion of an ink system 50a (see FIG. 2), and a controller 100. The other portion of the ink system 50a is mounted on the carriage 20. The ink system 50a includes an ink head 50. Also, an ultraviolet lamp 55 is provided in the carriage 20.

The printer main body 11 houses the flat bed 40, the portion of the ink system 50a, and the controller 100. The printer main body 11 is herein a portion of the printer 10, which is exclusive of the carriage 20 that is a movable portion, a mounted member on the carriage 20, the carriage mover 30, the ink system 50a, and the controller 100. The printer main body 11 preferably has a box shape a front surface of which is opened. The printer main body 11 extends in a left-right direction. The printer main body 11 houses the flat bed 40, the portion of the ink system 50a, and the controller 100 inside. The printer main body 11 includes a front cover 12 which can open and close a front opening.

The carriage mover 30 is configured to move the carriage 20. The carriage mover 30 includes a guide rail 31, a belt 32, left and right pullies (not illustrated), and a scan motor 33. The carriage 20 slidably engages with the guide rail 31. The guide rail 31 is fixed to the printer main body 11 and extends in the left-right direction. The guide rail 31 guides movement of the carriage 20 in the left-right direction. The belt 32 is fixed to the carriage 20. The belt 32 is an endless belt. The belt 32 is wound around the pullies (not illustrated) provided at left and right of the guide rail 31. The scan motor 33 is attached to one of the pullies. The scan motor 33 is electrically connected to the controller 100. The scan motor 33 is controlled by the controller 100. When the scan motor 33 is driven, the pullies rotate and the belt 32 runs. Accordingly, the carriage 20 moves in the left-right direction along the guide rail 31.

The flat bed 40 is disposed in or substantially in a center position in the left-right direction in an internal space of the printer main body 11. The flat bed 40 is a structure on which a recording medium 5 is placed. The printer 10 according to this preferred embodiment is a so-called flat-bad printer. There is no particular limitation on a shape of the recording medium 5 and the recording medium 5 may be formed into various three-dimensional shapes in addition to a flat-plate shape. Also, there is no particular limitation on a material of the recording medium 5 and the recording medium 5 may be formed of, for example, wood, metal, glass, paper, fabric, or the like.

A bed mover 41 is disposed under the flat bed 40. The bed mover 41 is configured to move the flat bed 40 in a front-rear direction and an up-down direction. The flat bed 40 is supported by the bed mover 41 from underneath. The bed mover 41 includes a first mover 41Z and a second mover 41X. The first mover 41Z supports the flat bed 40 and moves the flat bed 40 in the up-down direction. Herein, the first mover 41Z includes a ball screw mechanism and a motor (not illustrated). The ball screw mechanism is driven by the motor. The first mover 41Z is supported by the second mover 41X from underneath. The second mover 41X supports the first mover 41Z and moves the first mover 41Z in the front-rear direction. The second mover 41X includes a ball screw mechanism and a motor (not illustrated). A configuration of the bed mover 41 is not limited. For example, the first mover 41Z and the second mover 41X may be disposed such that an upper and lower positional relation of the first mover 41Z and the second mover 41X becomes reversed. The bed mover 41 is electrically connected to the controller 100 and is controlled by the controller 100.

The carriage 20 movably engages with the printer main body 11 via the guide rail 31. The carriage 20 holds a plurality of ink heads 50 on its a lower surface. The plurality of ink heads 50 is mounted on the carriage 20. The plurality of ink heads 50 is disposed in line in the left-right direction in the carriage 20. A plurality of nozzles configured to eject an ink is provided in a lower surface of each of the ink heads 50. The nozzle is a fine hole through which the ink is ejected. Although illustration is omitted, in each of the ink heads 50, the plurality of nozzles is disposed in line in the front-rear direction to form a nozzle array. Note that, three ink heads 50 are illustrated herein but the number of the ink heads 50 is not limited.

The ultraviolet lamp 55 is provided in the carriage 20. The ultraviolet lamp 55 is herein provided on a left side surface of the carriage 20. The ultraviolet lamp 55 extends in the front-rear direction. The ultraviolet lamp 55 irradiates the flat bed with an ultraviolet ray. The ultraviolet lamp 55 is electrically connected to the controller 100 and is controlled by the controller 100.

An actuator including a piezoelectric element is provided inside each of the plurality of ink heads 50. The actuator is provided for each nozzle. Each actuator is driven, and thereby, the corresponding nozzle ejects the ink. Each actuator includes a pressure chamber which communicates with the nozzle and in which the ink is stored and a piezoelectric element contacting the pressure chamber. When a voltage that is applied to the piezoelectric element is changed, the piezoelectric element expands and contracts and, due to displacement of the piezoelectric element, a volume of the pressure chamber changes. Due to this change in volume of the pressure chamber, the ink is ejected from the nozzle. The plurality of actuators is electrically connected to the controller 100 and is controlled by the controller 100.

FIG. 2 is a schematic view illustrating a configuration of the ink system 50a. The ink system 50a is provided for each ink head 50. FIG. 2 is a view illustrating one ink system 50a. As illustrated in FIG. 2, the ink system 50a includes an ink supply system 60, an ink circulation system 70, and an ink discharge system 80. A portion of the ink system 50a is mounted on the printer main body 11 and the other portion of the ink system 50a is mounted on the carriage 20.

The ink supply system 60 supplies the ink to the ink circulation system 70 inside the carriage 20. The ink supply system 60 is provided in the printer main body 11. The ink supply system 60 is herein provided near a right end of the printer main body 11. The ink supply system 60 includes a main ink container 61, a first attachment 62, a supply flow path 63, a supply pump 64, and a filter 65.

The main ink container 61 is provided in the printer main body 11 and the ink is stored in the main ink container 61. The main ink container 61 is herein an ink cartridge. However, the main ink container 61 is not limited to an ink cartridge and, for example, may be a tank or a pouch. One kind of ink is stored in one main ink container 61. A material of the ink is not limited and various materials each of which has been conventionally used as a material of an ink of an ink jet printer may be used. The ink is herein an ultraviolet curing ink which is cured by receiving an ultraviolet ray. The number of main ink containers 61 is the same as the number of the ink heads 50. The plurality of main ink containers 61 may be provided to store different kinds of inks. The main ink containers 61 may be configured such that some of the main ink containers 61 store the same kind of ink.

The first attachment 62 is provided in the printer main body 11. Specifically, as illustrated in FIG. 2, the first attachment 62 is attached to one side surface of the printer main body 11. The side surface faces in a direction of the carriage 20 (a left side herein). As illustrated in FIG. 2, the first attachment 62 includes a check valve 62a and a connecting nozzle 62b.

The check valve 62a is configured to be opened when a pressure is applied in a direction toward outside from inside of the ink supply system 60. There is no particular limitation on a configuration of the check valve 62a. The check valve 62a includes herein a valve body 62a1 and a spring 62a2. The spring 62a2 presses the valve body 62a1 toward the main ink container 61. When a pressure inside the ink supply system 60 is low, the valve body 62a1 closes the supply flow path 63 by a pressing force of the spring 62a2. The supply flow path 63 is a flow path connecting the main ink container 61 and the first attachment 62. The supply flow path 63 preferably includes a flexible tube. The check valve 62a is configured to be opened when the supply pump 64 is driven and a force that is applied to the valve body 62a1 by an ink pressure inside the ink supply system 60 is stronger than pressing force of the spring 62a2.

The connecting nozzle 62b is exposed to outside of the printer main body 11. The connecting nozzle 62b is disposed to face toward the carriage 20 (the left side herein). The connecting nozzle 62b includes a nozzle member 62b1, a flow path 62b2, and a seal member 62b3. The nozzle member 62b1 preferably has a needle shape. The nozzle member 62b1 protrudes toward the carriage 20. The flow path 62b2 is located inside the nozzle member 62b1. The flow path 62b2 communicates with the main ink container 61 via the check valve 62a. Also, the flow path 62b2 is opened at a tip of the nozzle member 62b1. Thus, when the supply pump 64 is driven and the check valve 62a is opened by the ink pressure, the ink is discharged from an end of the flow path 62b2 disposed at the tip of the nozzle member 62b1. The seal member 62b3 is provided in an outer circumference portion of the nozzle member 62b1. The seal member 62b3 is formed of an elastic material having seal performance. The seal member 62b3 seals the first attachment 62 and a second attachment 72 (which will be described later) of the ink circulation system 70 such that the ink does not leak when the first attachment 62 and the second attachment 72 are connected to each other. Note that a seal member may be provided in the second attachment 72 not in the first attachment 62.

The supply pump 64 is connected to the main ink container 61 and the first attachment 62. The supply pump 64 is configured to deliver the ink from the main ink container 61 toward the first attachment 62. The supply pump 64 is herein a tube pump. However, the supply pump 64 is not limited to a tube pump and may be, for example, a diaphragm pump or the like. The supply pump 64 is connected to the controller 100 and is controlled by the controller 100. The supply pump 64 is an example of an ink deliverer configured to move the ink to a sub-ink container 71 which will be described later from the main ink container 61.

The filter 65 is provided between the supply pump 64 and the first attachment 62. The filter 65 acquires a foreign substance or the like mixed in the ink. Even when the foreign substance is mixed in the ink in the ink supply system 60, the filter 65 keeps the foreign substance from reaching the ink circulation system 70.

The ink circulation system 70 is mounted on the carriage 20. The ink circulation system 70 circulates the ink in order to reduce sedimentation of an ink component. The ink circulation system 70 includes the sub-ink container 71, the second attachment 72, an upstream side flow path 73, a downstream side flow path 74, a circulation pump 75, a buffer tank 76, a leakage preventive valve 78, and a heater 79.

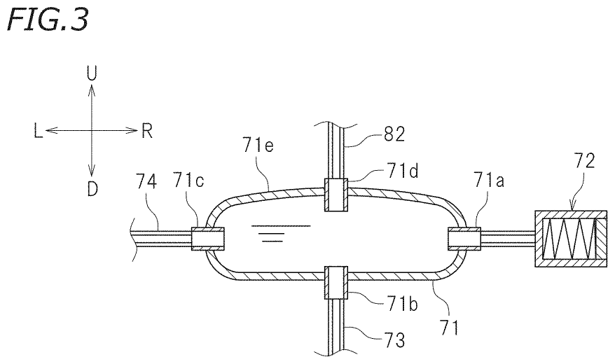

The sub-ink container 71 is mounted on the carriage 20. The sub-ink container 71 is capable of storing the ink. FIG. 3 is a cross-sectional view schematically illustrating the sub-ink container 71. As illustrated in FIG. 3, the sub-ink container 71 is a sealed container. However, a first port 71a to which a flow path leading to the second attachment 72 is connected, a second port 71b to which the upstream side flow path 73 is connected, a third port 71c to which the downstream side flow path 74 is connected, and a fourth port 71d to which a discharge flow path 82 (which will be described later) is connected are formed. The sub-ink container 71 is preferably made of a flexible material. The sub-ink container 71 is configured to be deformed in accordance with an ink amount inside of the sub-ink container 71 so that an internal volume changes. The sub-ink container 71 is herein a pouch.

The sub-ink container 71 is configured to have a smaller internal volume than that of the main ink container 61. There is no particular limitation on the internal volume of the sub-ink container 71 and, for example, the internal volume is about 50 ml or so at maximum. Also, the sub-ink container 71 has a flat shape. The sub-ink container 71 is herein disposed so as to extend in a horizontal direction. The short side of the sub-ink container 71 corresponds to the up-down direction.

The sub-ink container 71 includes a top surface 71e facing upward. As used herein, the top surface means a surface, among surfaces of the sub-ink container 71, which faces upward. Depending on a direction in which the sub-ink container 71 is disposed, the top surface is not always a wide surface. Also herein, the sub-ink container 71 is a flexible pouch and a shape of the top surface 71e is not fixed. The fourth port 71d is located in the top surface 71e of the sub-ink container 71 and one end of the discharge flow path 82 is connected to the fourth port 71d.

The first port 71a is located in a side surface (a right side surface) of the sub-ink container 71, which is closer to the ink supply system 60, and the second attachment 72 is connected to the first port 71a via a flow path. The second port 71b is located in a bottom surface of the sub-ink container 71 and the upstream side flow path 73 is connected to the second port 71b. The third port 71c is located in a left side surface of the sub-ink container 71 and the downstream side flow path 74 is connected to the third port 71c.

The sub-ink container 71 is disposed above the ink head 50. The ink head 50 is connected to the sub-ink container 71. The ink is supplied to the ink head 50 from the sub-ink container 71 by a water head pressure generated by a difference in height between the sub-ink container 71 and the ink head 50. The sub-ink container 71 has flexibility and is configured to be deformed in accordance with the ink amount inside the sub-ink container 71 so as not to disturb the ink supply by the water head pressure. Thus, the ink behaves in a close manner to that in a case where the sub-ink container 71 is opened to air.

The second attachment 72 is mounted on the carriage 20 and is connected to the sub-ink container 71. The second attachment 72 is connectable to the first attachment 62. The first attachment 62 and the second attachment 72 are connected to each other such that the ink can move. Thus, the main ink container 61 and the sub-ink container 71 communicate with each other when the first attachment 62 and the second attachment 72 are connected to each other.

The second attachment 72 is provided in a side surface (a right side surface herein) of the carriage 20, which is closer to the ink supply system 60. As illustrated in FIG. 2, the second attachment 72 includes a guide hole 72a and a check valve 72b. The guide hole 72a extends in the left-right direction. A right end of the guide hole 72a is opened in a right side surface of the carriage 20. A left end of the guide hole 72a is connected to a flow path connecting the sub-ink container 71 and the second attachment 72 via the check valve 72b. The guide hole 72a has an inner diameter corresponding to an outer circumference of the nozzle member 62b1 of the first attachment 62.

The check valve 72b has a similar configuration to that of the check valve 62a of the first attachment 62. The check valve 72b is configured to be opened when a pressure is applied in a direction toward inside of the ink circulation system 70. The check valve 72b includes a valve body 72b1 and a spring 72b2. The spring 72b2 presses the valve body 72b1 toward the ink supply system 60. In a normal state, the valve body 72b1 closes the guide hole 72a by an internal pressure of the ink circulation system 70 and a pressing force of the spring 72b2.

The first attachment 62 and the second attachment 72 are configured to be connected to each other when the carriage 20 is set in a home position P1 (see FIG. 1). The home position P1 is a position in which the carriage 20 is set during print standby. The carriage mover 30 is configured to set the carriage 20 in the home position P1. The home position P1 is set to one end of a movable range of the carriage 20. The home position P1 is set to a right end of the movable range of the carriage 20 in this preferred embodiment. The home position P1 is an example of a position of the carriage 20 in which the first attachment 62 and the second attachment 72 are connected to each other and the main ink container 61 and the sub-ink container 71 communicate with each other. The first attachment 62 and the second attachment 72 are configured to be separated from each other when the carriage 20 is set in a position other than the home position P1.

The first attachment 62 and the second attachment 72 are disposed at the same height. Also, the first attachment 62 and the second attachment 72 are disposed in the same position in the front-rear direction. Thus, the carriage 20 moves in the left-right direction, and thereby, the connecting nozzle 62b of the first attachment 62 is inserted in or separated from the guide hole 72a of the second attachment 72. When the connecting nozzle 62b is inserted in the guide hole 72a of the second attachment 72, the check valve 72b is pressed toward the sub-ink container 71 by the tip of the nozzle member 62b1. Thus, the check valve 72b is opened and the main ink container 61 and the sub-ink container 71 communicate with each other. When the connecting nozzle 62b is removed from the guide hole 72a of the second attachment 72, the check valve 72b is closed and the main ink container 61 and the sub-ink container 71 are disconnected from each other. As described above, the main ink container 61 and the second attachment 72 are configured to communicate with each other when the first attachment 62 and the second attachment 72 are connected to each other.

The upstream side flow path 73 connects the sub-ink container 71 and the ink head 50. The downstream side flow path 74 connects the sub-ink container 71 and the ink head 50. The ink head 50 is connected to the sub-ink container 71 via the upstream side flow path 73 and the downstream side flow path 74. The upstream side flow path 73 and the downstream side flow path 74 form a circulation flow path 70a between the sub-ink container 71 and the ink head 50, through which the ink circulates. Each of the upstream side flow path 73 and the downstream side flow path 74 is a relatively short flow path arranged inside the carriage 20. Herein, each of the upstream side flow path 73 and the downstream side flow path 74 preferably includes a flexible tube.

The circulation pump 75 is provided in the downstream side flow path 74. The circulation pump 75 is configured such that the ink is delivered to from the ink head 50 toward the sub-ink container 71. Thus, a circulation flow in which the ink flows from the sub-ink container 71 through the upstream side flow path 73 to reach the ink head 50 and returns to the sub-ink container 71 from the ink head 50 through the downstream side flow path 74 is provided. The circulation pump 75 is herein a tube pump. However, the circulation pump 75 is not limited to a tube pump and may be, for example, a diaphragm pump or the like. The circulation pump 75 is connected to the controller 100 and is controlled by the controller 100.

The buffer tank 76 is provided in the downstream side flow path 74. The buffer tank 76 is provided between the ink head 50 and the circulation pump 75. The buffer tank 76 includes a storage chamber 76a, an inflow port 76b, and an outflow port 76c.

The storage chamber 76a is configured to store the ink. The buffer tank 76 includes the storage chamber 76a as an internal space. The inflow port 76b is located in a bottom surface of the storage chamber 76a. The inflow port 76b is connected to the ink head 50 via a portion of the downstream side flow path 74, which extends to the ink head 50 from the buffer tank 76. During circulation of the ink, the ink flows in from the inflow port 76b to the storage chamber 76a. The outflow port 76c is located in one surface side of the storage chamber 76a. The outflow port 76c is connected to the sub-ink container 71 via another portion of the downstream side flow path 74, which extends to the sub-ink container 71 from the buffer tank 76. During circulation of the ink, the ink flows out from the outflow port 76c. The inflow port 76b and the outflow port 76c communicate with each other via the storage chamber 76a. During circulation of the ink, the ink that has flowed in from the inflow port 76b is temporarily stored in the storage chamber 76a and flows out from the outflow port 76c.

The outflow port 76c is located in the middle of one side surface of the storage chamber 76a in a height direction. The storage chamber 76a extends to a position above the outflow port 76c. Thus, basically, in the storage chamber 76a, the ink is stored only up to a height of the outflow port 76c. A portion of a space in the storage chamber 76a, which is above the outflow port 76c, defines an upper space 76a1 in which the ink is basically not stored. When inflow of the ink is temporarily excessive due to pulsation of the circulation pump 75, the ink is stored in the upper space 76a1. When outflow of the ink is temporarily excessive, the outflow ink is refilled with the ink stored in the storage chamber 76a. As described above, the buffer tank 76 reduces or prevents influences of the pulsation of the circulation pump 75.

A pressure sensor 77 is provided in the buffer tank 76. The pressure sensor 77 detects a pressure of the storage chamber 76a. The pressure sensor 77 is configured to send a signal, for example, when a pressure of the ink inside the storage chamber 76a is lower than a predetermined pressure. The pressure sensor 77 is connected to the controller 100. The controller 100 receives the signal sent by the pressure sensor 77. The controller 100 controls driving of the circulation pump 75, based on the signal from the pressure sensor 77. A configuration of the pressure sensor 77 is not limited. The pressure sensor 77 may be, for example, a sensor configured to continuously measure a pressure and may be, for example, a mechanical or optical sensor a contact point of which is turned on and off by the predetermined pressure.

Note that the buffer tank 76 may be provided in the downstream side flow path 74 and may not be provided in an upstream side of the circulation pump 75. Also, the pressure sensor 77 may be provided in the upstream side flow path 73 or the downstream side flow path 74 and may be configured to detect a pressure of the upstream side flow path 73 or the downstream side flow path 74. The pressure sensor 77 may not be provided in the buffer tank 76.

The leakage preventive valve 78 is provided in the upstream side flow path 73. The leakage preventive valve 78 is configured to be opened when a secondary power source of the printer 10 is on and to be closed when the secondary power source is off. The leakage preventive valve 78 reduces leakage of the ink in the sub-ink container 71 from the ink head 50 when the secondary power source of the printer 10 is off. The leakage preventive valve 78 is, for example, a solenoid valve.

The heater 79 is provided so as to contact the sub-ink container 71. The heater 79 is mounted on the carriage 20. The heater 79 heats the sub-ink container 71 in order to keep viscosity of the ink at a predetermined level. The ink in the circulation flow path 70a is controlled to fixed temperature by the heater 79. The heater 79 is electrically connected to the controller 100 and is controlled by the controller 100. The heater 79 is controlled to be a predetermined temperature by the controller 100.

The ink discharge system 80 is connected to the sub-ink container 71. A portion of the ink discharge system 80 is mounted on the carriage 20 and the other portion of the ink discharge system 80 is mounted on the printer main body 11. The ink discharge system 80 includes a waste liquid tank 81, the discharge flow path 82, a discharge valve 83, and an ink detector 84.

The waste liquid tank 81 is mounted on the printer main body 11. The waste liquid tank 81 is opened to air. Waste ink is discarded into the waste liquid tank 81. The waste liquid tank temporarily stores the waste ink.

One end of the discharge flow path 82 is connected to the top surface 71e of the sub-ink container 71 and the other end of the discharge flow path 82 is connected to the waste liquid tank 81. The discharge flow path 82 preferably includes a flexible tube. The discharge flow path 82 connects the sub-ink container 71 mounted on the carriage 20 and the waste liquid tank 81 mounted on the printer main body 11 to each other.

The discharge valve 83 is provided in the discharge flow path 82 and is configured to open and close the discharge flow path 82. The discharge valve 83 is herein mounted on the carriage 20. However, the discharge valve 83 may be mounted on the printer main body 11. The discharge valve 83 is, for example, a solenoid valve. The discharge valve 83 is electrically connected to the controller 100 and is controlled by the controller 100.

The ink detector 84 is provided in the discharge flow path 82. The ink detector 84 is configured to detect the ink. The ink detector 84 is provided, for example, in a connection portion of the discharge flow path 82 with the waste liquid tank 81. The ink detector 84 detects that the ink has passed through the discharge flow path 82 and has reached the waste liquid tank 81. There is no particular limitation on a configuration of the ink detector 84. For example, the ink detector 84 includes an optical sensor. In that case, the ink detector 84 detects, based on a change in a light-receiving level depending on a color of the ink, whether there is the ink. However, the configuration of the ink detector 84 is not limited to the above described configuration and the ink detector 84 may be, for example, an electrification type ink detector including an electrode, or the like. The ink detector 84 is configured to send a signal when the ink detector 84 detects the ink. The ink detector 84 is electrically connected to the controller 100. The controller 100 receives the signal from the ink detector 84 and controls each member, such as the discharge valve 83 or the like.

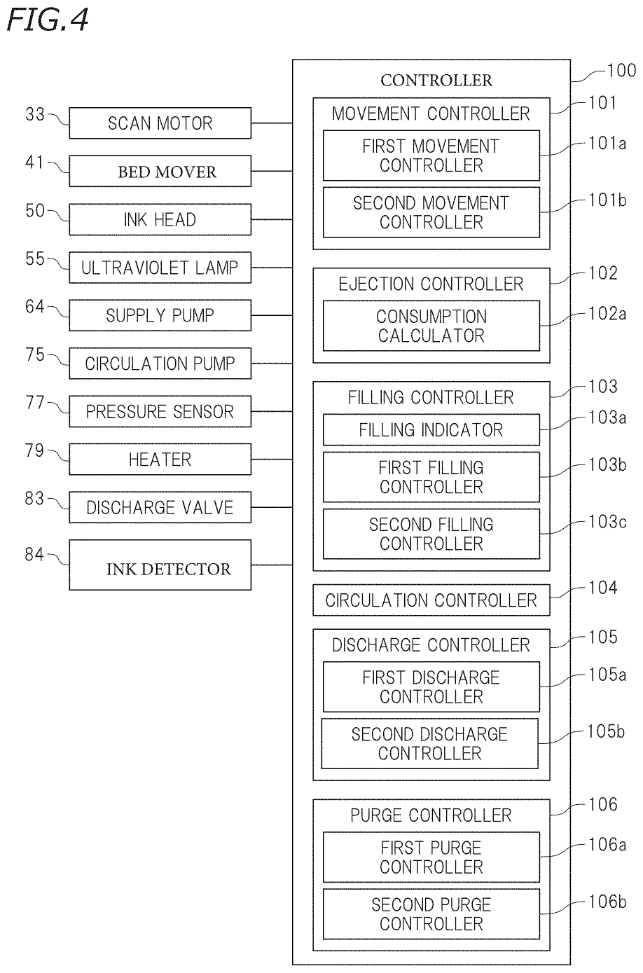

As illustrated in FIG. 1, the controller 100 configured to control various operations of the printer 10 is housed in a right end of the printer 10. FIG. 4 is a block diagram of the printer 10 according to this preferred embodiment. As illustrated in FIG. 4, the controller 100 is connected to the scan motor 33, the bed mover 41, the ink head 50, the ultraviolet lamp 55, the supply pump 64, the circulation pump 75, the heater 79, and the discharge valve 83 and controls operations of these elements. Also, the controller 100 is connected to the pressure sensor 77 and the ink detector 84 and receives signals from the elements. The controller 100 includes a movement controller 101, an ejection controller 102, a filling controller 103, a circulation controller 104, a discharge controller 105, and a purge controller 106.

There is no particular limitation on a configuration of the controller 100. The controller 100 may be, for example, a microcomputer. There is no particular limitation on a hardware configuration of the microcomputer. The microcomputer includes, for example, an interface (I/F) configured or programmed to receive print data or the like from an external device, such as a host computer or the like, a central processing unit (CPU) configured or programmed to execute an order of a control program, a read-only memory (ROM) configured or programmed to store a program that is executed by the CPU, a random access memory (RAM) used as a working area in which the program is developed, and a storage, such as a memory or the like, configured or programmed to store the above described program and various types of data.

The movement controller 101 controls movement of the carriage 20 by controlling the carriage mover 30. As illustrated in FIG. 4, the movement controller 101 includes a first movement controller 101a and a second movement controller 101b. The first movement controller 101a is configured or programmed to control the carriage mover 30 and set the carriage 20 in the home position P1 during a non-printing time. The second movement controller 101b is configured or programmed to control the carriage mover 30 and cause the carriage 20 to move in a position spaced apart from the home position P1 during a printing time. Specifically, the second movement controller 101b is configured or programmed to cause the carriage 20 to move over the flat bed 40. Movement of the carriage 20 during the printing time is controlled by the second movement controller 101b.

The ejection controller 102 controls an ink dispensing operation. The ejection controller 102 controls the ink head 50 to cause the ink head 50 to eject the ink in the sub-ink container 71 during the printing time. Due to this operation, printing is performed on the recording medium 5 placed on the flat bed 40. The ejection controller 102 includes a consumption calculator 102a. The consumption calculator 102a calculates ink consumption in printing. This calculation is performed based on print data.

The filling controller 103 controls a filling process of filling the ink in the main ink container 61 to the sub-ink container 71. The filling controller 103 is configured or programmed to control the supply pump 64 as an ink deliverer to cause the supply pump 64 to move the ink to the sub-ink container 71 from the main ink container 61 when the carriage 20 is set in the home position P1. As illustrated in FIG. 4, the filling controller 103 includes a filling indicator 103a, a first filling controller 103b, and a second filling controller 103c.

The filling indicator 103a instructs to move the ink to the sub-ink container 71 from the main ink container 61, based on the consumption of the ink, which has been calculated by the consumption calculator 102a. In addition, the filling indicator 103a instructs to fill the ink to the sub-ink container 71 when it is considered that the ink amount of the sub-ink container 71 has been reduced by purge, which will be described later, or the like. A method in which the filling indicator 103a determines a timing of filling, based on the consumption of the ink, is not limited. The filling indicator 103a herein instructs to fill the ink when the carriage 20 returns to the home position P1 for the first time after the consumption of the ink has reached a predetermined amount.

The first filling controller 103b and the second filling controller 103c control each element to move the ink to the sub-ink container 71 from the main ink container 61. The first filling controller 103b is configured to open the discharge valve 83 in a state in which the carriage 20 is set in the home position P1. The second filling controller 103c is configured to drive the supply pump 64 after the discharge valve 83 is opened by the first filling controller 103b. Details of an ink filling process will be described later.

The circulation controller 104 controls an ink circulation operation in the circulation flow path 70a. The circulation controller 104 is configured or programmed to control the circulation pump 75 such that a pressure that is detected by the pressure sensor 77 is controlled within a predetermined pressure range. In other words, the circulation controller 104 controls driving of the circulation pump 75, based on the ink pressure in the circulation flow path 70a, which is detected by the pressure sensor 77, such that the ink pressure is a desired pressure. Herein, the circulation controller 104 causes the ink to circulate at regular intervals except during the printing time. Also, the circulation controller 104 usually causes the ink to circulate during filling of the ink to the ink circulation system 70 or during the printing time.

The discharge controller 105 controls a discharge process of discharging the ink in the circulation flow path 70a to the waste liquid tank 81. The discharge controller 105 executes the discharge process, for example, regularly or as appropriate (for example, by a command of a user). As illustrated in FIG. 4, the discharge controller 105 includes a first discharge controller 105a and a second discharge controller 105b. In the discharge process, the first discharge controller 105a is configured or programmed to open the discharge valve 83. The second discharge controller 105b is configured or programmed to drive the circulation pump 75 after the discharge valve 83 is opened by the first discharge controller 105a. Details of the ink discharge process will be described later.

The purge controller 106 controls the purge process of expelling the ink from the nozzle of the ink head 50. In the purge process, the ink is expelled by ink delivery by the supply pump 64, not by vibration of the actuator of the ink head 50. The purge controller 106 executes the purge process, for example, regularly or as appropriate. As illustrated in FIG. 4, the purge controller 106 includes a first purge controller 106a and a second purge controller 106b. The first purge controller 106a is configured or programmed to close the discharge valve 83 in a state in which the carriage 20 is set in the home position P1. The second purge controller 106b is configured or programmed to drive the supply pump 64 after the discharge valve 83 is closed by the first purge controller 106a. Details of the ink purge process will be described later.

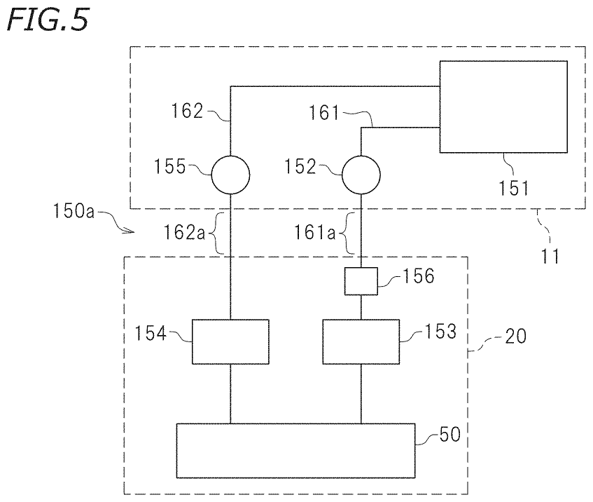

An operation of the printer 10 according to this preferred embodiment will be described below in comparison with a printer including a typical known ink system as appropriate. FIG. 5 is a schematic view illustrating an example of a configuration of a known ink system 150a. As illustrated in FIG. 5, the known ink system 150a includes an ink container 151, an upstream side pump 152, an upstream side damper 153, a downstream side damper 154, a downstream side pump 155, a heater 156, and an ink head 50. Of these elements, the ink container 151, the upstream side pump 152, and the downstream side pump 155 are mounted on the printer main body 11. The upstream side damper 153, the downstream side damper 154, the heater 156, and the ink head 50 are mounted on the carriage 20.

Also in the known ink system 150a, the ink circulates in a circulation flow path. The circulation flow path causes the ink to circulate between the ink container 151 and the ink head 50. The upstream side pump 152 is disposed in an upper side flow path 161 on an upstream side from the ink head 50 in a flow of the ink. In a downstream side of the upstream side pump 152, the upstream side damper 153 is disposed. The upstream side pump 152 is mounted on the printer main body 11 and the upstream side damper 153 is mounted on the carriage 20. The upstream side pump 152 and the upstream side damper 153 are connected to each other via a tube 161a. The tube 161a has a necessary length for the carriage 20 to move with respect to the printer main body 11. The tube 161a has a length of, for example, about 2 m or more.

The downstream side pump 155 is disposed in a downstream side flow path 162 on a downstream side from the ink head 50 in the flow of the ink. The downstream side damper 154 is disposed in a side of the downstream side pump 155, which is closer to the ink head 50. The downstream side pump 155 is mounted on the printer main body 11 and the downstream side damper 154 is mounted on the carriage 20. The downstream side pump 155 and the downstream side damper 154 are connected to each other via a tube 162a. The tube 162a also has a length of, for example, about 2 m or more.

The heater 156 is provided in an upstream of the upstream side damper 153. The heater 156 is mounted on the carriage 20.

The upstream side damper 153 includes a storage chamber in which the ink is temporarily stored and a pressure sensor configured to send a signal when a pressure of the storage chamber is a predetermined pressure or less or more. In a typical pressure sensor, one surface of the storage chamber is a film that expands and contracts in accordance with a pressure inside the storage chamber and whether the pressure of the storage chamber is the predetermined pressure or more or less is detected by detecting expansion and contraction of the film. The downstream side damper 154 has the same configuration.

In the known ink system 150a, for example, the upstream side pump 152 is driven at fixed rotation speed. The downstream side pump 155 reduces rotation speed or stops when an ink pressure inside the downstream side damper 154, which is detected by the pressure sensor, is lower than a predetermined pressure. Also, the downstream side pump 155 is configured to start driving or increase the rotation speed when the ink pressure inside the downstream side damper 154 exceeds the predetermined pressure. The upstream side damper 153 and the downstream side damper 154 send signals that control the ink pressure and reduces pressure fluctuation by the storage chamber.

The above described known ink system 150a has, for example, the following problems. One of the problems is that, because the tubes 161a and 162a that are connected so as to extend between the printer main body 11 and the carriage 20 are long, a large space in which the tubes 161a and 162a are arranged is needed. The carriage 20 moves in the left-right direction during the printing time and not during the printing time. Thus, the tubes 161a and 162a need to have a length corresponding to the movable range of the carriage 20. A distance between the carriage 20 and the ink container 151 is small, the tubes 161a and 162a are largely bent. An enough space in which the bent tubes 161a and 162a are arranged is needed in the known ink system 150a. Specifically, a flat-bed printer generally has a small size and the above described space causes increase in size of the entire printer. Also, a cover that shields an ultraviolet ray is needed for a printer including an ultraviolet lump and, because of existence of the cover, a constraint is imposed on a way in which the tubes 161a and 162a are arranged.

Another problem is that the tubes 161a and 162a are moved by movement of the carriage 20 during the printing time and the pressure of the ink inside the tubes 161a and 162a varies (which will be hereinafter referred to as dynamic pressure fluctuation as appropriate). In the known ink system 150a, the tubes 161a and 162a are long, and therefore, the dynamic pressure fluctuation is large. In order to reduce the dynamic pressure fluctuation, the upstream side damper 153 and the downstream side damper 154 are needed.

Still another problem is that, because the circulation flow path is long, a large output is needed for the heater 156. When the circulation flow path is long, a heat radiation amount of the ink during circulation is large. In order to keep temperature of the ink at predetermined temperature, a large amount of heat is needed for the heater 156.

The printer 10 according to this preferred embodiment is configured to be able to solve the above described problems. The printer 10 according to this preferred embodiment includes the sub-ink container 71 mounted on the carriage 20 and the first attachment 62 and the second attachment 72 configured to cause the main ink container 61 and the sub-ink container 71 to communicate with each other in a predetermined position (the home position P1 herein) of the carriage 20. In the printer 10 according to this preferred embodiment, an ink flow path that extends between the printer main body 11 and the carriage 20 is not needed. Therefore, a space in which the ink flow path is arranged is not needed. Also, the dynamic pressure fluctuation of an ink caused by movement of carriage 20 is able to be reduced or prevented. Furthermore, the ink flow path is able to be shortened, and therefore, an output of the heater is able to be reduced.

In the printer 10 according to this preferred embodiment, when the consumption of the ink exceeds the predetermined amount and thereafter the carriage 20 returns to the home position P1 for the first time, filling of the ink to the sub-ink container 71 is performed. When the first attachment 62 and the second attachment are connected to each other, the check valves 62a and 72b function to cause the main ink container 61 and the sub-ink container 71 to communicate with each other. On the other hand, when the first attachment 62 and the second attachment 72 are separated from each other, the check valves 62a and 72b function as valves such that the ink does not leak from each of the main ink container 61 and the sub-ink container 71. Each of the check valves 62a and 72b is configured to be opened when the first attachment 62 and the second attachment 72 are connected to each other and then a pressure is applied in a direction toward the sub-ink container 71 from the main ink container 61. According to this configuration, connection and disconnection of the flow path is able to be achieved without performing electrical control using, for example, electromagnetic valves or the like. Thus, the number of members and costs are able to be reduced. Note that the check valve 62a of the first attachment 62 and the check valve 72b of the second attachment 72 can individually function, and therefore, even when only one of the check valve 62a and the check valve 72b is used, the above described advantageous effects are able to be achieved.

Furthermore, in this preferred embodiment, the first attachment 62 includes the connecting nozzle 62b. The connecting nozzle 62b is configured to press the check valve 72b in a direction toward the sub-ink container 71 from the main ink container 61 when the first attachment 62 and the second attachment 72 are connected to each other. Also, the connecting nozzle 62b includes the flow path 62b2 that communicates with the main ink container 61. Thus, the check valve 72b is opened by connection of the first attachment 62 and the second attachment 72, and the main ink container 61 and the sub-ink container 71 communicate with each other via the flow path 62b2. According to the above described configuration, it is possible to reliably cause the main ink container 61 and the sub-ink container 71 to communicate with each other in a simple manner.

In this preferred embodiment, the position of the carriage 20 when ink filling to the sub-ink container 71 is performed is set to one end of the movable range of the carriage 20. More specifically, the position of the carriage 20 when ink filling to the sub-ink container 71 is performed is set to the home position P1 that is one end of the movable range of the carriage 20 and is a standby position of the carriage 20 during the non-printing time. According to the configuration in which the position of the carriage 20 during ink filling is set to one end of the movable range of the carriage 20, positioning of the carriage 20 is simplified. Also, even without a special mechanism, the first attachment 62 and the second attachment 72 are able to be connected to each other by movement of the carriage 20. For example, when a position in which the ink is filled is set in middle of the movable range of the carriage 20, for example, a mechanism configured to cause the second attachment 72 to protrude on a movement path of the carriage 20 and further store the second attachment 72 from the position is needed.

According to the configuration in which the position of the carriage 20 during ink filling is set to the home position P1, the carriage 20 is necessarily set in a position in which ink filling is performed during the non-printing time. Therefore, special control in which the carriage 20 is caused to move for ink filling is not needed.

In the ink filling process, first, the carriage 20 is set in the home position P1 (a first process). Thus, the main ink container 61 and the sub-ink container 71 are caused to communicate with each other. Next, the discharge valve 83 is opened (a second process). Next, the supply pump 64 is driven (a third process). Furthermore, when the circulation pump 75 is not driven, the circulation pump 75 is driven (a fourth process). The third process and the fourth process may be performed in a reversed order and may be simultaneously performed. Then, after a predetermined time has elapsed since detection of the ink by the ink detector 84 provided in the discharge flow path 82, the supply pump 64 is stopped and the discharge valve 83 is closed (a fifth process).

In the filling process, air in the circulation flow path 70a is removed by opening the discharge valve 83. The air in the circulation flow path 70a is lighter than the ink and stays around the top surface 71e. As illustrated in FIG. 3, the discharge flow path 82 is connected to the top surface 71e of the sub-ink container 71. Thus, when the discharge valve 83 is opened, the ink in the circulation flow path 70a is discharged from the discharge flow path 82. When a state in which the ink detector 84 provided in the discharge flow path 82 detects the ink continues for a fixed time, it is determined that discharge of the air is completed and only the ink is discharged. Then, the supply pump 64 is stopped and the discharge valve 83 is closed. The filling process is accordingly completed. However, a method for determining whether the ink has been filled to the circulation flow path 70a is not limited to the above described manner. For example, whether the ink has been filled to the circulation flow path 70a may be determined based on an ink filling time. The controller 100 grasps the consumption of the ink, based on print data. Accordingly, the controller 100 also grasps a residual amount of the ink in the circulation flow path 70a. Thus, whether filling is completed can be determined merely based on the filling time. In the printer 10 according to this preferred embodiment, by performing the above described process, the ink is able to be filled in the circulation flow path 70a while the air is removed.

The filling of the ink to the sub-ink container 71 is automatically performed by control of the filling controller 103. Therefore, there is no need for the user to perform an operation in order to fill the ink to the sub-ink container 71. Also, the filling of the ink is performed based on the consumption of the ink in printing. Therefore, the ink can be reliably replenished before the ink of the sub-ink container 71 runs short.

The first attachment 62 and the second attachment 72 are separated from each other when the carriage 20 is set in a position other than the home position P1. Therefore, in a position other than the home position P1 that is a position in which the ink is filled, movement of the carriage 20 is not be constrained by the first attachment 62.

Note that the above described filling process may be performed not only in filling that is performed when the ink in the sub-ink container 71 has been reduced but also in initial filling that is performed in a state in which the ink is not stored in the sub-ink container 71 in the same manner. Also, the above described filling process may be performed after purge or discharge of the ink.

The ink that has been filled in the ink circulation system 70 circulates in the circulation flow path 70a. In circulation of the ink, supply of the ink to the ink head 50 from the sub-ink container 71 is performed by a water head pressure difference between the sub-ink container 71 and the ink head 50. The sub-ink container 71 is disposed above the ink head 50 and is configured as a flexible sealed container. Thus, the ink is able to be supplied to the ink head 50 from the sub-ink container 71 by the water head pressure difference between the sub-ink container 71 and the ink head 50.

As illustrated in FIG. 2, in this preferred embodiment, a pump and a damper are not provided in the upstream side flow path 73. The ink system 50a according to this preferred embodiment does not include a long ink flow path that extends between the printer main body 11 and the carriage 20. Thus, the ink does not dynamically fluctuate much. Therefore, a damper used to reduce pressure fluctuation is not provided in the upstream side flow path 73. Because there is no damper, the ink can be supplied up to the ink head 50 by a water head pressure. Therefore, the printer 10 according to this preferred embodiment does not include a pump at an upstream side.

As described above, with the printer 10 according to this preferred embodiment, dynamic pressure fluctuation of the ink is able to be reduced, and therefore, an element or structure configured to reduce influences of the dynamic pressure fluctuation of a damper or the like is able to be omitted. Also, a member, such as a pump or the like, which is conventionally provided because a damper or the like is provided, is able to be omitted.

Also, the carriage 20 is able to be made in a compact size by reducing components. Herein, the internal volume of the sub-ink container 71 is smaller than that of the main ink container 61 and each element is configured to realize a smaller size of the carriage 20.

Returning of the ink to the sub-ink container 71 from the ink head 50 is performed by the circulation pump 75. The circulation controller 104 controls the circulation pump 75 such that a pressure that is detected by the pressure sensor 77 is controlled to within a predetermined pressure range. When the pressure that is detected by the pressure sensor 77 is lower than the predetermined pressure, the circulation controller 104 reduces rotation speed of the circulation pump 75 or stops the circulation pump 75. When the pressure that is detected by the pressure sensor is higher than the predetermined pressure, the circulation controller 104 increases the rotation speed of the circulation pump 75. Alternatively, when the circulation pump 75 has been stopped, the circulation controller 104 starts driving the circulation pump 75. According to the above described configuration, the printer 10 is able to control the pressure of the ink in the circulation flow path 70a to a desired pressure.

Note that, in this preferred embodiment, the buffer tank 76 is provided in the downstream side flow path 74 and the pressure fluctuation of the ink caused by pulsation of the circulation pump 75 is reduced.

Furthermore, in this preferred embodiment, the circulation flow path 70a is located inside the carriage 20. A length of the circulation flow path 70a is considerably short, as compared to the known ink system 150a. Thus, heat radiation of the circulation flow path 70a is low and the output of the heater 79 is able to be reduced.

In this preferred embodiment, discharge of the ink in the circulation flow path 70a is performed regularly or as appropriate. In the discharge process, first, the discharge valve is opened (the first process). Subsequently, when the circulation pump 75 is not driven, the circulation pump 75 is driven (the second process). The first process and the second process may be performed in a reversed order and may be simultaneously performed. Then, after the ink detector 84 detects the ink, detection of the ink is stopped, when such a state continues for a certain time, the circulation pump 75 is stopped, and the discharge valve 83 is closed (the third process). The discharge controller 105 controls the above described discharge process. The ink in the circulation flow path 70a is able to be discharged by the above described control.

The printer 10 according to this preferred embodiment is configured to perform purge in which the ink is expelled from the nozzle of the ink head 50 regularly or as appropriate. In the purge process, first, the carriage 20 is set in the home position P1 and the main ink container 61 and the sub-ink container 71 communicate with each other (the first process). The first process may be omitted when the carriage 20 has been already set in the home position P1. Next, the discharge valve 83 is opened (the second process). The second process may be omitted when the discharge valve 83 has been already closed. Subsequently, the supply pump 64 is driven (the third process). The second process and the third process may be simultaneously performed. The purge controller 106 is configured or programmed to execute the purge process including the first process in which the carriage mover 30 is controlled such that the carriage 20 is set in the home position P1, the second process in which the discharge valve 83 is closed, and the third process in which the supply pump 64 is driven. By the above described control, purge in which the ink is expelled from the nozzle of the ink head 50 is able to be performed.

One preferred embodiment of the present invention has been described above. However, the above-described preferred embodiment is merely an example and the present invention may be implemented in various other forms. For example, in the above described preferred embodiment, the ink deliverer configured to move the ink to the sub-ink container 71 from the main ink container 61 includes the supply pump 64. The ink deliverer is not limited to the above described configuration. The ink deliverer may be configured to deliver the ink, for example, by the water head pressure difference between the main ink container 61 and the sub-ink container 71. In such a case, a valve that is connected to the controller 100 and is controlled by the controller 100 may be provided.

In this preferred embodiment, the ink system 50a includes the ink circulation system 70. The ink system 50a may not include the ink circulation system 70. Preferred embodiments of the present invention disclosed herein may not be only on a premise of use for a circulation system and can be preferably applied to, for example, an ink system which does not include a return flow path of the ink.

Furthermore, in the above described preferred embodiment, the position of the carriage 20 in which the first attachment 62 and the second attachment 72 are connected to each other is set to the home position P1. The position is not limited to the above described position. There is no particular limitation on the position of the carriage 20 in which the first attachment 62 and the second attachment 72 are connected to each other. In that case, the carriage 20 is set in the position in which the first attachment 62 and the second attachment 72 are connected to each other during a part of the non-printing time and is set in a home position during the other part of the non-printing time. The position of the carriage 20 in which the first attachment 62 and the second attachment 72 are connected to each other may be set to, for example, a different end of the movable range of the carriage 20 from the home position (for example, an end in an opposite side to the home position in the left-right direction when the carriage 20 moves only in the left-right direction). According to the above described configuration, advantages of setting the position in which the first attachment 62 and the second attachment 72 are connected to each other to an end of the movable range of the carriage 20 are able to be achieved and arrangement of each element in the home position is able to be simplified because the mechanisms do not concentrate in the home position.

In addition, a configuration of an ink jet printer is not limited unless specifically stated otherwise. For example, preferred embodiments of the present invention disclosed herein may be used for a roll-to-roll ink jet printer or the like. Also, for example, preferred embodiments of the present invention may be used for a device, such as, for example, a printer with cutting head or the like, which has a portion in which an ink jet printer is incorporated.

The terms and expressions used herein are for description only and are not to be interpreted in a limited sense. These terms and expressions should be recognized as not excluding any equivalents to the elements shown and described herein and as allowing any modifications encompassed in the scope of the claims. The present invention may be embodied in many various forms. The present invention should be regarded as providing preferred embodiments of the principles of the present invention. These preferred embodiments are provided with the understanding that they are not intended to limit the present invention to the preferred embodiments described in the specification and/or shown in the drawings. The present invention encompasses any of preferred embodiments including equivalent elements, modifications, deletions, combinations, improvements and/or alterations which can be recognized by a person of ordinary skill in the art based on preferred embodiments of the present invention. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An ink jet printer comprising:
a printer body;
a carriage to movably engage with the printer body;
a carriage mover to move the carriage;
a main ink container provided in the printer body and in which an ink is stored;
a first attachment provided in the printer body and connected to the main ink container;
a sub-ink container mounted on the carriage;
an ink head mounted on the carriage and connected to the sub-ink container; and
a second attachment mounted on the carriage and connected to the sub-ink container; wherein
the carriage mover is movable to set the carriage in a first position;
the first attachment and the second attachment are connected to each other when the carriage is set in the first position; and
the main ink container and the sub-ink container communicate with each other when the first attachment and the second attachment are connected to each other.

2. The ink jet printer according to claim 1, wherein at least one of the first attachment and the second attachment includes a check valve to be opened when the first attachment and the second attachment are connected to each other and then a pressure is applied in a direction toward the sub-ink container from the main ink container.

3. The ink jet printer according to claim 2, wherein
the second attachment includes the check valve; and
the first attachment includes a connection nozzle to press the check valve in the direction toward the sub-ink container from the main ink container when the first attachment and the second attachment are connected to each other and including a flow path that communicates with the main ink container.

4. The ink jet printer according to claim 1, wherein the first position is set to one end of a movable range of the carriage.

5. The ink jet printer according to claim 1, further comprising:
an ink deliverer to move the ink to the sub-ink container from the main ink container; and
a controller including:
a first movement controller to control the carriage mover to set the carriage in the first position during at least a part of a non-printing time;
a second movement controller to control the carriage mover to move the carriage in a position separated from the first position during a printing time;
a filling controller to control the ink deliverer when the carriage is set in the first position to move the ink to the sub-ink container from the main ink container; and
an ejection controller to control the ink head to cause the ink head to eject the ink in the sub-ink container during the printing time.

6. The ink jet printer according to claim 5, wherein
the first movement controller sets the carriage in a home position that has been set to one end of the movable range of the carriage during the non-printing time; and the first position is the home position.

7. The ink jet printer according to claim 5, wherein
the first movement controller sets the carriage in the first position during at least a part of the non-printing time and sets the carriage in the home position that has been set to the one end of the movable range of the carriage during other time than a time during which the carriage is set in the first position in the non-printing time; and
the first position has been set to a different end of the movable range of the carriage from the home position.

8. The ink jet printer according to claim 5, wherein the ink deliverer includes a first pump connected to the main ink container and the first attachment to deliver the ink toward the first attachment from the main ink container.

9. The ink jet printer according to claim 5, wherein
the ejection controller includes a consumption calculator to calculate consumption of the ink during printing; and
the filling controller includes a filling indicator to instruct to move the ink to the sub-ink container from the main ink container, based on the consumption of the ink, which has been calculated by the consumption calculator.

10. The ink jet printer according to claim 1, wherein the sub-ink container has a smaller internal volume than that of the main ink container.

11. The ink jet printer according to claim 1, wherein the sub-ink container is a flexible sealed container and is disposed above the ink head.

12. The ink jet printer according to claim 11, further comprising:
a first flow path connecting the ink head and the sub-ink container;
a second flow path connecting the ink head and the sub-ink container; and
a second pump provided in the second flow path to deliver the ink toward the sub-ink container from the ink head.

13. The ink jet printer according to claim 12, further comprising:
a pressure sensor provided in the first flow path or the second flow path to detect a pressure of the first flow path or the second flow path; and
a controller including a circulation controller to control the second pump such that the pressure detected by the pressure sensor is controlled within a predetermined pressure range.

14. The ink jet printer according to claim 12, further comprising:
a buffer tank provided in the second flow path including:
a storage chamber in which the ink is stored;
an inflow port provided in the storage chamber and connected to the ink head via a portion of the second flow path; and
an outflow port provided in the storage chamber and connected to the sub-ink container via another portion of the second flow path; and
the storage chamber extends to a position above the inflow port.

15. The ink jet printer according to claim 12, wherein
the sub-ink container includes a top surface facing upward;
the ink jet printer further includes:
a first pump connected to the main ink container and the first attachment to deliver the ink from the main ink container toward a first attachment side from a main ink container;
a waste liquid tank;
a third flow path one end of which is connected to the top surface of the sub-ink container and the other end of which is connected to the waste liquid tank;
a first valve provided in the third flow path and configured to open and close the third flow path; and
a controller including:
a movement controller to control the carriage mover to set the carriage in the first position; and
a filling controller to move the ink to the sub-ink container from the main ink container; and
the filling controller includes:
a first filling controller to open the first valve in a state in which the carriage is set in the first position; and
a second filling controller to drive the first pump after the first valve has been opened by the first filling controller.

16. The ink jet printer according to claim 15, wherein
the controller includes a purge controller to execute purging of the ink;
the purge controller includes:
a first purge controller to close the first valve in a state in which the carriage is set in the first position; and
a second purge controller to drive the first pump after the first valve has been closed by the first purge controller.

17. The ink jet printer according to claim 1, further comprising:
a heater mounted on the carriage and contacting the sub-ink container.

18. The ink jet printer according to claim 1, wherein the first attachment and the second attachment are separated from each other when the carriage is set in a position other than the first position.
